(19) United States
(12) Patent Application Publication
(10) Pub. No.: US 2024/0357548 A1
(43) Pub. Date: Oct. 24, 2024

(54) ELECTRIC MOBILITY DEVICE COMMUNICATION SYSTEM FOR A SERVICE AREA

(71) Applicant: GM Global Technology Operations LLC, Detroit, MI (US)

(72) Inventors: Prakash M. Peranandam, Rochester Hills, MI (US); Jayant Sachdev, Toronto (CA); Md Mhafuzul Islam, Warren, MI (US)

(21) Appl. No.: 18/303,060

(22) Filed: Apr. 19, 2023

(51) Int. Cl. H04W 64/00; G01C 21/00; G06T 19/00; H04N 7/18; H04W 76/14

(52) U.S. Cl. CPC H04W 64/006; G01C 21/3807; G01C 21/3896; G06T 19/003; H04N 7/185; H04W 76/14; G06Q 10/0875

(57) ABSTRACT

An electric mobility device communication system includes one or more electric mobility devices located within a service area, one or more remotely located client servers, and one or more central computers in wireless communication with the one or more electric mobility devices and the one or more remotely located client servers. The central computers execute instructions to receive a service request from one of the client servers. The service request represents a task that one of the electric mobility devices executes within the service area. The central computers determine a total number of electric mobility devices available within the service area. In response to determining more than one electric mobility device is available within the service area, the central computers identify an electric mobility device that executes the service request based on one or more electric mobility device selection criteria and transmit the service request to the electric mobility device.

### INTRODUCTION

The present disclosure relates to an electric mobility device communication system including one or more electric mobility devices located in a service area that are each in wireless communication with one or more central computers, where one of the electric mobility devices execute a service request generated by a client server.

An electric mobility device, which is sometimes referred to as an e-pallet or electric pallet, is a purpose-built, electrically propelled mobile cart that may be used to transport goods within a service area. The service area may be an enclosed structure such as a building. Alternatively, the service area may include a geofenced area having a predefined layout such as, for example, a portion of a city having a mapped layout or a campus for a school, hospital, or a corporation. For example, electric mobility devices may transport inventory from one location to another within a retail store or a warehouse. Some types of electric mobility devices are fully autonomous and require no propulsion assistance from a human, while other types of electric mobility devices require propulsion assistance from a human when traveling from one location to another.

In one approach, the electric mobility device may include a secured container, such as a locker, for storing goods that are transported from one location to another. The secured container may be tracked by an electronic tagging device such as, for example, a barcode. In addition to a secured container, the autonomous electric mobility device is equipped with various perception sensors such as, but not limited to, cameras that capture image data of the surrounding environment, LiDAR, radar, laser distance measuring devices, an inertial measurement unit (IMU), speed sensors, wheel angle sensors, and a global positioning system (GPS).

While electric mobility devices achieve their intended purpose, there is a need in the art for improved approach for utilizing electric mobility devices within a service area.

### SUMMARY

According to several aspects, an electric mobility device communication system including one or more electric mobility devices located within a service area and one or more remotely located client servers is disclosed. The electric mobility device communication system includes one or more central computers in wireless communication with the one or more electric mobility devices and the one or more remotely located client servers. The one or more central computers execute instructions to receive a service request from one of the client servers, where the service request represents a task that one of the electric mobility devices executes within the service area. The one or more central computers determine a total number of electric mobility devices available within the service area. In response to determining more than one electric mobility device is available within the service area, the central computers identify an electric mobility device that executes the service request based on one or more electric mobility device selection criteria. The central computers transmit the service request to the electric mobility device, where the electric mobility device executes the service request within the service area.

In another aspect, in response to transmitting the service request to the electric mobility device, the one or more central computers access one or more map files that represent a predetermined layout of the service area, and transmit the one or more map files to the electric mobility device.

In yet another aspect, the one or more central computers execute instructions to receive, from the electric mobility device, spatial differences in the predetermined layout represented by the one or more map files and a predetermined layout represented by a perception model created by the electric mobility device and determine a timeframe of the spatial differences, where the timeframe indicates the spatial differences are caused by either a short-term change or a long-term change.

In an aspect, the perception model representative of the predetermined layout of the service area is based on perception data captured by a plurality of perception sensors that are part of the electric mobility device.

In another aspect, in response to determining the timeframe of the spatial differences is the long-term change, the one or more central computers update the one or more map files that represent the predetermined layout of the service area with the spatial differences.

In yet another aspect, the one or more central computers execute instructions to establish a direct peer-to-peer communication link between the client server and the electric mobility device.

In an aspect, a live video feed or stationary images are captured by one or more cameras of the electric mobility device is transmitted over the peer-to-peer communication link to the client server.

In another aspect, a specific item of inventory stored within the service area is involved as part of the service request.

In yet another aspect, the one or more central computers execute instructions to transmit a complete profile of the specific item of inventory to the one or more central computers, where the complete profile of the specific item of inventory indicates retail specific information and product specific information for the specific item of inventory.

In an aspect, the one or more central computers execute instructions to receive a live video feed or stationary images of the specific item of inventory captured by one or more cameras of the electric mobility device and transmit the complete profile of the specific item of inventory and the live video feed to one of the client servers.

In another aspect, the task is one of the following: providing a continuous video stream to a client server, procuring a specific item of inventory at a destination location within the service area, capturing image data of an environment of the service area to create a three-dimensional virtual space that is representative of the environment and is saved in a virtual reality space for a virtual reality window shopping request, determining the specific item of inventory is available within the service area, and detecting abnormalities within the service area.

In yet another aspect, the one or more electric mobility device selection criteria includes one or more of the following: a distance between a current location of each electric mobility device versus a location within the service area of the service request, perception capabilities of the one or more electric mobility devices, a computing power of each of the one or more electric mobility devices, a current task list of each of the one or more electric mobility devices, a state-of-charge of a battery of each of the one or more electric mobility devices, and network availability of each of the one or more electric mobility devices.

In an aspect, a method of executing a service request by an electric mobility device communication system including one or more electric mobility devices located within a service area and one or more remotely located client servers is disclosed. The method includes receiving, by one or more central computers, the service request from one of the one or more client servers, where the service request represents a task that one of the electric mobility devices executes within the service area, and where the one or more central computers are in wireless communication with the one or more electric mobility devices and the one or more remotely located client servers. The method also includes determining, by the one or more central computers, a total number of electric mobility devices available within the service area. In response to determining more than one electric mobility device is available within the service area, the method includes identifying an electric mobility device that executes the service request based on one or more electric mobility device selection criteria. Finally, the method includes transmitting the service request to the electric mobility device, where the electric mobility device executes the service request within the service area.

In another aspect, in response to transmitting the service request to the electric mobility device, the method includes accessing one or more map files that represent a predetermined layout of the service area and transmitting the one or more map files to the electric mobility device.

In yet another aspect, the method includes receiving, from the electric mobility device, spatial differences in the predetermined layout represented by the one or more map files and a predetermined layout represented by a perception model created by the electric mobility device and determining a timeframe of the spatial differences, where the timeframe indicates the spatial differences are caused by either a short-term change or a long-term change.

In an aspect, in response to determining the timeframe of the spatial differences is the long-term change, the method includes updating the one or more map files that represent the predetermined layout of the service area with the spatial differences.

In another aspect, an electric mobility device communication system including one or more remotely located client servers is disclosed. The electric mobility device communication system includes one or more electric mobility devices located within a service area and one or more central computers in wireless communication with the one or more electric mobility devices and the one or more remotely located client servers. The one or more central computers execute instructions to receive a service request from one of the client servers, wherein the service request represents a task that one of the electric mobility devices executes within the service area. The central computers determine a total number of electric mobility devices available within the service area. In response to determining more than one electric mobility device is available within the service area, the central computers identify an electric mobility device that executes the service request based on one or more electric mobility device selection criteria. The central computers transmit the service request to the electric mobility device, where the electric mobility device executes the service request within the service area.

In an aspect, in response to transmitting the service request to the electric mobility device, the central computers access one or more map files that represent a predetermined layout of the service area and transmit the one or more map files to the electric mobility device.

In another aspect, the one or more central computers execute instructions to receive, from the electric mobility device, spatial differences in the predetermined layout represented by the one or more map files and a predetermined layout represented by a perception model created by the electric mobility device and determine a timeframe of the spatial differences, where the timeframe indicates the spatial differences are caused by either a short-term change or a long-term change.

In yet another aspect, in response to determining the timeframe of the spatial differences is the long-term change, the central computers update the one or more map files that represent the predetermined layout of the service area with the spatial differences.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of the disclosed electric mobility device communication system including one or more electric mobility devices within a service area, where the electric mobility devices are in wireless communication with one or more central computers that are part of a back-end office and one or more client servers, according to an exemplary embodiment;

FIG. 2 is an illustration of an aisle located within the service area shown in FIG. 1, according to an exemplary embodiment;

FIG. 3 is a schematic diagram of one of the electric mobility devices shown in FIG. 1, according to an exemplary embodiment;

FIG. 4 is a process flow diagram illustrating a method for executing a service request generated by one or more client servers by one of the electric mobility devices, according to an exemplary embodiment; and

FIG. 5 is a process flow diagram illustrating another method for updating one or more map files based on perception data collected by one of the electric mobility devices, according to an exemplary embodiment.

### DETAILED DESCRIPTION

The following description is merely exemplary in nature and is not intended to limit the present disclosure, application, or uses.

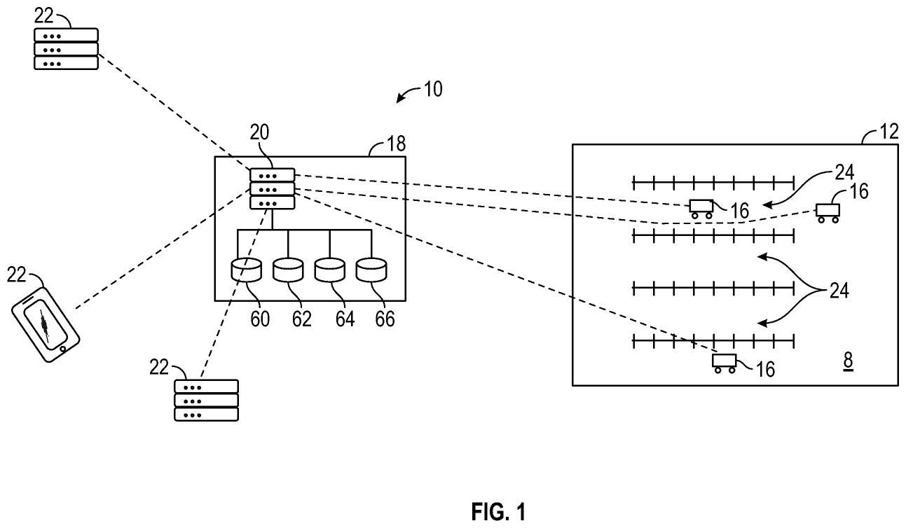

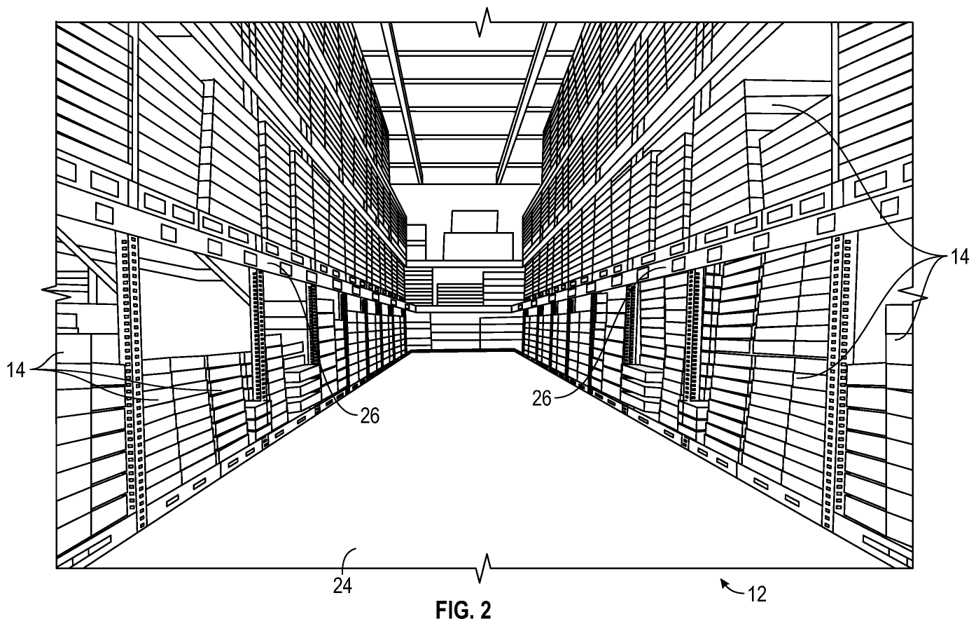

Referring to FIG. 1, an exemplary electric mobility device communication system 10 is illustrated. The electric mobility device communication system 10 includes one or more electric mobility devices 16 located within a service area 12, one or more central computers 20 that are part of a back-end office 18, and one or more remotely located client servers 22. The one or more central computers 20 of the back-end office 18 are in wireless communication with each of the electric mobility devices 16 and each of the remotely located client servers 22 based on any type of wireless communication protocol. As explained below, the electric mobility devices 16 are electrically propelled mobile carts that travel throughout an environment 8 of the service area 12. The service area 12 may represent any type of defined geographical area having a predetermined layout such as an enclosed structure or a geofenced area. In one embodiment, the service area 12 is a building such as a warehouse, manufacturing service area, or retail store. In another embodiment, the service area 12 is a campus for a hospital, school, or corporation. In one embodiment, the service area 12 contains inventory 14 (shown in FIG. 2), where the inventory 14 is arranged in a predetermined layout. It is to be appreciated that the predetermined layout may be dynamic and change periodically as well.

In the example as shown in FIGS. 1 and 2, the predetermined layout of the service area 12 may include one or more aisles 24 that are located between shelves 26 containing the inventory 14. The inventory 14 may be arranged in predetermined locations along the one or more aisles 24 of the service area 12, where the inventory 14 represents any type of goods. In the example as shown in FIG. 2, the service area 12 is a wholesale club retail store where the inventory 14 includes items such as canned beverages, pet food, or snacks. Although FIGS. 1 and 2 illustrate the predetermined layout of the service area 12 as including one or more aisles 24, it is to be appreciated that the figures are merely exemplary in nature and predetermined layout of the service area 12 is not limited to the aisles 24. In another embodiment, the predetermined layout of the service area 12 may be defined based on features such as, for example pedestrian walkways, passages between buildings, or points of interests. The predetermined layout may include a specific design such as, for example, free-flow, boutique, fixed path, loop, minimum movement, or a virtual reality based dynamic arrangement.

Referring to FIG. 1, the client servers 22 each represent a computing device that receives user input or a request for service. The client servers 22 may be, for example, desktop computers, vehicle infotainment systems, laptop computers, tablets, or smartphones. In one non-limiting embodiment, the client servers 22 may be remotely located at a location separate from the service area 12 such as, for example, at a user's home or office. As explained below, one of the client servers 22 may generate a service request in response to receiving user input, where the service request represents a task that one of the electric mobility devices 16 executes at a destination location within the service area 12. The task may be, for example, providing a continuous video stream to the client server 22 so that a user may view the inventory 14 within the service area 12 (which is referred to as window shopping), procuring a specific item of inventory 14 at the destination location within the service area 12 (which is referred to as remote shopping), capturing image data of the environment 8 of the service area 12 to create a three-dimensional virtual space that is representative of the environment 8 and is saved in a virtual reality space for a virtual reality window shopping request, determining the specific item of inventory is available within the service area 12, or detecting abnormalities within the service area 12. Some examples of abnormalities within the service area 12 include, but are not limited to, housekeeping issues, lighting devices that are inoperative, and maintenance issues. One example of a housekeeping issue is identifying debris, such as liquids or broken glass, spilled on the floor of the service area 12.

The service request includes a plurality of required parameters such as, but not limited to, a service request time, a request type, a requested information type, an information request, a requested information location, and a requested response type. The service request time refers to the day and time the task is to be performed. The request type indicates if the task is periodic or sporadic, and if there is a time limit. The requested information type indicates if the task relates to remote shopping, determining product availability, creating a three-dimensional virtual space, or detecting abnormalities. The information request relates to the status of the specific item of inventory 14 (i.e., if the product is available at the service area 12). The requested information location refers to the physical address and/or name of the service area 12. The requested response type indicates if the electric mobility device 16 should send updates to the one or more central computers 20 of the back-end office 18 or to one of the client servers 22. In an embodiment, the service request may also include one or more optional parameters as well such as, for example, a requested data type or a requested information location. The requested data type may refer to the data type (e.g., image file versus a video) when sending a reply to the client server 22 in response to receiving the service request from the client server 22. The requested information location refers to the location of the specific item of inventory 14, such as an aisle or bay number.

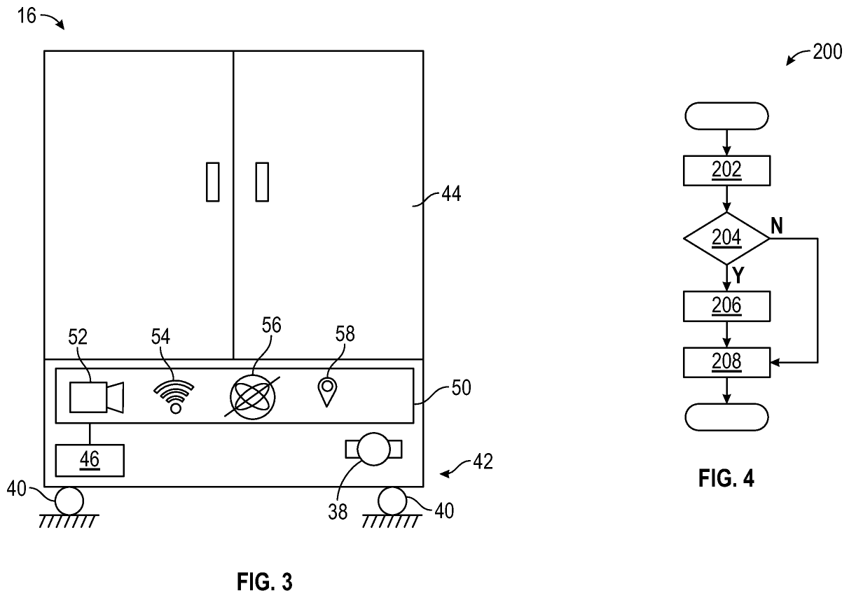

FIG. 3 is a schematic diagram of one of the electric mobility devices 16 shown in FIG. 1. As mentioned above, the electric mobility devices 16 are electrically propelled mobile carts that travel throughout the service area 12. The electric mobility devices 16 include a propulsion device 38 such as, for example, a battery-powered electric motor. The electric mobility devices 16 also include a plurality of wheels 40 that are located along a bottom portion 42 of the electric mobility device 16, where the bottom portion 42 of the electric mobility device 16 supports a secure container 44 such as, for example, a storage locker. It is to be appreciated that in one embodiment the electric mobility device 16 is fully autonomous and requires no intervention by a human when traveling throughout the service area 12. Alternatively, in another embodiment, the electric mobility device 16 may require propulsion assistance from a human when traveling through the service area 12. Although not shown in FIG. 3, in an embodiment the electric mobility device 16 may include one or more robotic arms or other motorized features for procuring the inventory 14 (FIG. 2) from the shelves 26 and placing the inventory 14 in the secure container 44.

The electric mobility device 16 includes one or more controllers 46 in wireless communication with the one or more central computers 20 that are part of the back-end office 18 (shown in FIG. 1). The electric mobility device 16 also includes a plurality of perception sensors 50 for collecting perception data regarding the service area 12 (FIG. 1), where the perception sensors 50 are in electronic communication with the one or more controllers 46. In the embodiment as shown in FIG. 3, the perception sensors 50 include one or more cameras 52, radar 54, an inertial measurement unit (IMU) 56, and a global positioning system (GPS) 58, however, is to be appreciated that additional or different perception sensors such as, for example, laser measuring devices for measuring distance may be used as well. The one or more cameras 52 capture image data of the environment of the service area 12. The image data may be transmitted to the client servers 22 via the one or more central computers 20 (FIG. 1) as an image or, alternatively, as a video. The IMU 56 and the GPS 58 may be used to determine a position of the electric mobility device 16 within the service area 12 (FIG. 1), where the position of each electric mobility device 16 is transmitted to the one or more central computers 20. As explained below, in the event more than one electric mobility device 16 is located within the service area 12, the one or more central computers 20 select one of the electric mobility devices 16 to execute the service request generated by a user based on one or more criteria.

Referring to FIGS. 1 and 3, in response to receiving a service request from one of the client servers 22, the one or more central computers 20 identify a location within the service area 12 of the service request, a time frame of the service request, and an action required by the service request. For example, if the service request is to determine if a specific product is in stock at a retail store, then the location within the service area 12 of the service request would indicate which aisle within the store the specific product is located (e.g., aisle 9), the time frame would indicate the service request should be executed as soon as possible, and the action required by the service request would include an answer indicating if the specific product is in stock.

In the event more than one electric mobility device 16 is located within the service area 12, the one or more central computers 20 first identify the electric mobility device 16 that executes the service request based on one or more electric mobility device selection criteria. The one or more central computers 20 first determine a current location and a current route of travel for each electric mobility device 16 within the service area 12 based on the perception data collected by the plurality of perception sensors 50. The central computers 20 then determine the electric mobility device 16 that executes the service request based on the one or more electric mobility device selection criteria. The one or more electric mobility device selection criteria includes factors such as, but not limited to, a distance between the current location of each electric mobility device 16 versus the location within the service area 12 of the service request, perception capabilities, computing power or capacity of each electric mobility device 16, a current task list of each electric mobility device 16, a state-of-charge of a battery of each electric mobility device 16, and a network availability of each electric mobility device 16. It is to be appreciated that in one embodiment, the one or more central computers 20 rank the electric mobility devices 16 based on the one or more electric mobility device selection criteria, and continuously updates the rank of the electric mobility devices 16 over time to reflect changing conditions.

Once the one or more central computers 20 identify the electric mobility device 16 that executes the specific request, the one or more central computers 20 transmit the service request to the electric mobility device 16 to execute. In one embodiment, a centralized communication flow exists between the one or more client servers 22, the central computers 20, and the electric mobility devices 16, where the one or more controllers 46 of the electric mobility device 16 (FIG. 3) communicates with the one or more central computers 20 directly when sending and receiving data from the one or more client servers 22.

Alternatively, in another embodiment, the one or more central computers 20 first establish communication with the one or more controllers 46 of the electric mobility device 16 first, and then establish a direct peer-to-peer communication link between one or more client servers 22 and the electric mobility device 16. In one non-limiting embodiment, the client server 22 may receive a live video feed or stationary images captured by the one or more cameras 52 (FIG. 3) of the electric mobility device 16 over the peer-to-peer communication link. During the live video feed, specific features related to security and privacy may be obscured in the image data by any technique such as, for example, blurring. The one or more controllers 46 of the electric mobility device 16 may execute algorithms for obscuring the specific features or, in the alternative, the one or more central computers 20 may obscure the specific features. In one embodiment, the client server 22 may control the electric mobility device 16 in real-time based on the live video feed captured by the one or more cameras 52. For example, the client server 22 may transmit a request to the electric mobility device 16 to procure items viewed during the live video feed automatically (i.e., in the event the electric mobility device 16 includes robotic arms or other motorized features) or manually by an individual.

In response to transmitting the service request to the electric mobility device 16, in an embodiment the one or more central computers 20 access one or more map files that represent the predetermined layout of the service area 12 that are saved on one or more layout databases 60. In the example as shown in FIG. 1, the one or more layout databases 60 are located at the back-end office 18, however, it is to be appreciated that the layout databases 60 may be situated in other locations as well. Some examples of the one or more map files include, but are not limited to, two-dimensional computer-aided design (CAD) data, three-dimensional CAD data, and building information modeling (BIM). The one or more central computers 20 transmit the one or more map files to the electric mobility device 16. It is to be appreciated that a copy of the one or more map files or a link to the location of the one or more map files may be transmitted to the electric mobility device 16.

Referring to FIGS. 1 and 3, the electric mobility device 16 travels toward the destination location within the service area 12 in response to receiving the service request from the one or more central computers 20. Specifically, the one or more controllers 46 of the electric mobility device 16 execute localization algorithms to determine a current position of the electric mobility device 16 within the service area 12, identify the destination location indicated by the service request, and calculate a route from the current position to the destination location. As the electric mobility device 16 travels towards the destination location within the service area 12, the plurality of perception sensors 50 capture perception data regarding the environment 8 of the service area 12. The one or more controllers 46 of the electric mobility device 16 build a perception model representative of the predetermined layout of the service area 12 based on the perception data captured by the plurality of perception sensors 50 by one or more machine learning algorithms such as, for example, deep neural networks, semantic segmentation, and ground segmentation.

In the event the electric mobility device 16 receives the one or more map files that represent the predetermined layout of the service area 12, the one or more controllers 46 of the electric mobility device 16 compares the predetermined layout of the service area 12 represented by the one or more map files with the predetermined layout represented by the perception model. In response to determining the predetermined layout is identical between the one or more data files and the perception model, then the one or more controllers 46 of the electric mobility device 16 determines no updates are required to the one or more data files. However, in response to determining a spatial difference in the predetermined layout represented by the one or more data files and the predetermined layout represented by the perception model, the one or more controllers 46 of the electric mobility device 16 transmit the spatial differences to the one or more central computers 20. The spatial differences in the predetermined layout may include, for example, changes in the location where inventory is located within the service area and changes to the overall layout of the service area. For example, the overall layout of the service area may change by moving the location of one or more aisles 24, a temporary closure because of construction, a road closure, renovations, or restocking.

In response to receiving the spatial difference in the predetermined layout represented by the one or more data files and the predetermined layout represented by the perception model, the one or more central computers 20 determine a timeframe associated with the spatial differences, where the timeframe indicates the difference is caused by either a short-term change or a long-term change. A short-term change indicates the spatial difference is caused by an event that will resolve within a matter of hours or days and is temporary. Some examples of short-term changes include, but are not limited to, temporary closure of an aisle, a blockage because of a spill or other debris on the floor, or a shelf being empty because a particular item in inventory is out of stock. A long-term change indicates the spatial difference is caused by a long-term event that will not change in the immediate future. Some examples of long-term changes include, but are not limited to, moving specific items of inventory to another aisle, a change in inventory, or renovations. In response to determining the timeframe of the spatial differences is a long-term change, the one or more central computers 20 updates the one or more map files that represent the predetermined layout of the service area 12 that are saved on one or more layout databases 60 with the spatial differences in the predetermined layout.

Once the electric mobility device 16 has reached the destination location within the service area 12, the one or more controllers 46 of the electric mobility device 16 receive image data from the one or more cameras 52 of the specific item of inventory stored within the service area 12 that is involved as part of the service request. The specific item of inventory may be part of a service request to procure the specific item of inventory 14 at the destination location within the service area 12 or determining the specific item of inventory is available within the service area 12. The image data captured by the one or more cameras 52 indicates an overall appearance of the specific item of inventory. The one or more controllers 46 of the electric mobility device 16 may execute one or more object recognition algorithms to identify the specific item of inventory such as, for example, one or more deep neural networks. In addition to the image data, in an embodiment the one or more controllers 46 of the electric mobility device 16 may also receive audio data regarding the service request such as, for example, voice commands or other sounds, and executes sound recognition algorithms to interpret the audio data. In another embodiment, the one or more controllers 46 of the electric mobility device 16 may receive wireless data regarding the service request that is transmitted based on approaches such as, for example, radio frequency identification (RFID) technology or near-field communication (NFC) technology.

The one or more controllers 46 of the electric mobility device 16 may then query one or more retail databases 62 and one or more product databases 64 for retail specific information related to the specific item of inventory and the one or more product databases 64 for product specific information regarding the specific item of inventory. The retail-specific information is based on store specific details for the specific item of inventory such as, for example, a price, any discounts, any special offers or coupons, return information (e.g., if the specific item is returnable), availability, quantity of the specific item at the service area 12, location within the service area 12 (e.g., aisle, bay, and rack number), and a expiry or sell-by date. The product specific information is based on specific details regarding the specific item of inventory itself such as, for example, product name, quantity, brand name, ingredients or contents, and a production batch or date.

In an embodiment, the image data may also include markings, such as text or a scannable barcode, such as a quick-response (QR) code, that indicate a classification of the specific item of inventory. In another example, wireless technology such as NFC or sound data such as voice or sound recognition algorithms may be used as well. In one embodiment, instead of executing one or more object recognition algorithms to identify the specific item of inventory, the one or more controllers 46 of the electric mobility device 16 may identify the specific item of inventory based on analyzing the markings instead. For example, the specific item of inventory may be identified based on text-recognition algorithms or by a scanning the barcode. It is to be appreciated that text-recognition algorithms and barcode require fewer computing resources when compared to executing object recognition algorithms. In another embodiment, the one or more controllers 46 of the electric mobility device 16 identifies the specific item of inventory by one or more object recognition algorithms in combination with analyzing the markings.

The one or more controllers 46 of the electric mobility device 16 combines the retail specific information from the one or more retail databases 62 and the product specific information from the one or more product databases 64 for the specific item of inventory together to create a complete profile of the specific item of inventory, and then transmits the complete profile of the specific item of inventory to the one or more central computers 20. In an embodiment, the central computer 20 may then save the complete profile of the specific item of inventory to one or more three-dimensional virtual space databases 66 that store data that is used to build a three-dimensional virtual space representative of the environment 8 of the service area 12, which may allow for virtual reality based remote requests even if no electric mobility device 16 is located within the area.

In one non-limiting embodiment, in addition to the complete profile of the specific item of inventory, the one or more central computers 20 receive a live video feed or stationary images captured by the one or more cameras 52 (FIG. 3) of the electric mobility device 16 of the specific item of inventory. The one or more central computers 20 may then transmit the complete profile of the specific item of inventory and the live video feed of the specific item of inventory to one of the client servers 22.

FIG. 4 is a process flow diagram illustrating an exemplary method 200 for executing a service request generated by a remotely located client server by an electric mobility device 16. Referring generally to FIGS. 1-4, the method 200 may begin at block 202. In block 202, the one or more central computers 20 receive a service request from one of the client servers 22. As mentioned above, the service request represents a task that one of the electric mobility devices 16 executes within the service area 12. The method 200 may then proceed to decision block 204.

In decision block 204, the one or more central computers 20 determines the total number of electric mobility devices available within the service area. In response to determining only one electric mobility device 16 is available within the service area 12, the method 200 proceeds to block 208. In response to determining more than one electric mobility device 16 is available within the service area 12, the method proceeds to block 206.

In block 206, the one or more central computers 20 identifies an electric mobility device 16 that executes the service request based on one or more electric mobility device selection criteria. The method 200 may then proceed to block 208.

In block 208, the one or more central computers 20 transmit the service request to the electric mobility device 16, where the electric mobility device 16 executes the service request within the service area 12. The method 200 may then terminate.

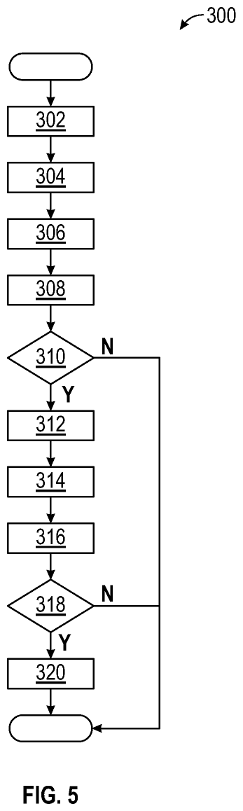

Referring now to FIG. 5, a method 300 for updating the one or more map files saved in the layout database 60 (FIG. 1) is illustrated. The method 300 begins at block 302. In block 302, the one or more central computers 20 transmit the service request to the electric mobility device 16. The method 300 may then proceed to block 304.

In block 304, in response to transmitting the service request to the electric mobility device 16, the one or more central computers 20 access the one or more map files that represent a predetermined layout of the service area 12. The method 300 may then proceed to block 306.

In block 306, the one or more central computers 20 transmits the one or more map files to the electric mobility device 16. The method 300 may then proceed to block 308.

In block 308, the one or more controllers 46 of the electric mobility device 16 build the perception model representative of the predetermined layout of the service area 12 based on the perception data captured by the plurality of perception sensors 50 (shown in FIG. 3). The method 300 may then proceed to decision block 310.

In decision block 310, the one or more controllers 46 of the electric mobility device 16 compares the predetermined layout of the service area 12 represented by the one or more map files with the predetermined layout represented by the perception model. In response to determining the predetermined layout is identical between the one or more data files and the perception model, then the one or more controllers 46 of the electric mobility device 16 determines no updates are required to the one or more data files, and the method terminates. In response to determining a spatial difference in the predetermined layout represented by the one or more data files and the predetermined layout represented by the perception model, the method 300 proceeds to block 312.

In block 312, the one or more controllers 46 of the electric mobility device 16 transmit the spatial differences to the one or more central computers 20. The method 300 may then proceed to block 314.

In block 314, the one or more central computers 20 receive, from the electric mobility device 16, the spatial differences in the predetermined layout represented by the one or more map files and a predetermined layout represented by a perception model created by the electric mobility device 16. The method 200 may then proceed to block 316.

In block 316, the one or more central computers 20 determine a timeframe of the spatial differences, where the timeframe indicates the difference is caused by either a short-term change or a long-term change. The method 300 may then proceed to decision block 318.

In decision block 318, in response to determining the timeframe of the differences is a short-term change, the method 300 may terminate. However, in response to determining the timeframe is a long-term change, the method 300 may proceed to block 320. In block 320, the one or more central computers 20 update the one or more map files that represent the predetermined layout of the service area 12 with the spatial differences. The method 300 may then terminate.

Referring generally to the figures, the disclosed electric mobility device communication system provides various technical effects and benefits. Specifically, the electric mobility device communication system provides an approach for executing service requests generated by a remotely located client server by an electric mobility device within a service area, where the service request includes collecting information regarding the environment of the service area. In one embodiment, the service request may allow for a user located at the client server to perform tasks such as window shopping or remote shopping. In another embodiment, the service request may include capturing image data of the environment of the service area to create a three-dimensional virtual space that is representative of the environment, which is stored in a database for providing a virtual reality experience. In another aspect, the service request may also include detecting abnormalities within the service area such as housekeeping issues, lighting devices that are inoperative, and maintenance issues.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An electric mobility device communication system including one or more electric mobility devices located within a service area and one or more remotely located client servers, the electric mobility device communication system comprising:
one or more central computers in wireless communication with the one or more electric mobility devices and the one or more remotely located client servers, wherein the one or more central computers execute instructions to:
receive a service request from one of the client servers, wherein the service request represents a task that one of the electric mobility devices executes within the service area;
determine a total number of electric mobility devices available within the service area;
in response to determining more than one electric mobility device is available within the service area, identify an electric mobility device that executes the service request based on one or more electric mobility device selection criteria; and
transmit the service request to the electric mobility device, wherein the electric mobility device executes the service request within the service area.

2. The electric mobility device communication system of claim 1, wherein the one or more central computers execute instructions to:
in response to transmitting the service request to the electric mobility device, access one or more map files that represent a predetermined layout of the service area; and
transmit the one or more map files to the electric mobility device.

3. The electric mobility device communication system of claim 2, wherein the one or more central computers execute instructions to:
receive, from the electric mobility device, spatial differences in the predetermined layout represented by the one or more map files and a predetermined layout represented by a perception model created by the electric mobility device; and
determine a timeframe of the spatial differences, wherein the timeframe indicates the spatial differences are caused by either a short-term change or a long-term change.

4. The electric mobility device communication system of claim 3, wherein the perception model representative of the predetermined layout of the service area is based on perception data captured by a plurality of perception sensors that are part of the electric mobility device.

5. The electric mobility device communication system of claim 3, wherein the one or more central computers execute instructions to:
in response to determining the timeframe of the spatial differences is the long-term change, update the one or more map files that represent the predetermined layout of the service area with the spatial differences.

6. The electric mobility device communication system of claim 1, wherein the one or more central computers execute instructions to:
establish a direct peer-to-peer communication link between the client server and the electric mobility device.

7. The electric mobility device communication system of claim 6, wherein a live video feed or stationary images are captured by one or more cameras of the electric mobility device is transmitted over the peer-to-peer communication link to the client server.

8. The electric mobility device communication system of claim 1, wherein a specific item of inventory stored within the service area is involved as part of the service request.

9. The electric mobility device communication system of claim 8, wherein the one or more central computers execute instructions to:
transmit a complete profile of the specific item of inventory to the one or more central computers, wherein the complete profile of the specific item of inventory indicates retail specific information and product specific information for the specific item of inventory.

10. The electric mobility device communication system of claim 9, wherein the one or more central computers execute instructions to:
receive a live video feed or stationary images of the specific item of inventory captured by one or more cameras of the electric mobility device; and
transmit the complete profile of the specific item of inventory and the live video feed to one of the client servers.

11. The electric mobility device communication system of claim 1, wherein the task is one of the following: providing a continuous video stream to a client server, procuring a specific item of inventory at a destination location within the service area, capturing image data of an environment of the service area to create a three-dimensional virtual space that is representative of the environment and is saved in a virtual reality space for a virtual reality window shopping request, determining the specific item of inventory is available within the service area, and detecting abnormalities within the service area.

12. The electric mobility device communication system of claim 1, wherein one or more electric mobility device selection criteria includes one or more of the following: a distance between a current location of each electric mobility device versus a location within the service area of the service request, perception capabilities of the one or more electric mobility devices, a computing power of each of the one or more electric mobility devices, a current task list of each of the one or more electric mobility devices, a state-of-charge of a battery of each of the one or more electric mobility devices, and network availability of each of the one or more electric mobility devices.

13. A method of executing a service request by an electric mobility device communication system including one or more electric mobility devices located within a service area and one or more remotely located client servers, the method comprising:
receiving, by one or more central computers, the service request from one of the one or more client servers, wherein the service request represents a task that one of the electric mobility devices executes within the service area, and wherein the one or more central computers are in wireless communication with the one or more electric mobility devices and the one or more remotely located client servers;
determining, by the one or more central computers, a total number of electric mobility devices available within the service area;
in response to determining more than one electric mobility device is available within the service area, identifying an electric mobility device that executes the service request based on one or more electric mobility device selection criteria; and
transmitting the service request to the electric mobility device, wherein the electric mobility device executes the service request within the service area.

14. The method of claim 13, further comprising:
in response to transmitting the service request to the electric mobility device, accessing one or more map files that represent a predetermined layout of the service area; and
transmitting the one or more map files to the electric mobility device.

15. The method of claim 14, further comprising:
receiving, from the electric mobility device, spatial differences in the predetermined layout represented by the one or more map files and a predetermined layout represented by a perception model created by the electric mobility device; and
determining a timeframe of the spatial differences, where the timeframe indicates the spatial differences are caused by either a short-term change or a long-term change.

16. The method of claim 15, further comprising:
in response to determining the timeframe of the spatial differences is the long-term change, updating the one or more map files that represent the predetermined layout of the service area with the spatial differences.

17. An electric mobility device communication system including one or more remotely located client servers, the electric mobility device communication system comprising:
one or more electric mobility devices located within a service area; and
one or more central computers in wireless communication with the one or more electric mobility devices and the one or more remotely located client servers, wherein the one or more central computers execute instructions to:
receive a service request from one of the client servers, wherein the service request represents a task that one of the electric mobility devices executes within the service area;
determine a total number of electric mobility devices available within the service area;
in response to determining more than one electric mobility device is available within the service area, identify an electric mobility device that executes the service request based on one or more electric mobility device selection criteria; and
transmit the service request to the electric mobility device, wherein the electric mobility device executes the service request within the service area.

18. The electric mobility device communication system of claim 17, wherein the one or more central computers execute instructions to:
in response to transmitting the service request to the electric mobility device, access one or more map files that represent a predetermined layout of the service area; and
transmit the one or more map files to the electric mobility device.

19. The electric mobility device communication system of claim 18, wherein the one or more central computers execute instructions to:
receive, from the electric mobility device, spatial differences in the predetermined layout represented by the one or more map files and a predetermined layout represented by a perception model created by the electric mobility device; and
determine a timeframe of the spatial differences, where the timeframe indicates the spatial differences are caused by either a short-term change or a long-term change.

20. The electric mobility device communication system of claim 19, wherein the one or more central computers execute instructions to:
in response to determining the timeframe of the spatial differences is the long-term change, update the one or more map files that represent the predetermined layout of the service area with the spatial differences.
